(19) United States
(12) Patent Application Publication
(10) Pub. No.: US 2013/0250408 A1
(43) Pub. Date: Sep. 26, 2013

(54) AUTO-STEREOSCOPIC DISPLAY APPARATUS

(71) Applicants: Hsin-Ying Wu, Yilan County (TW); Cheng-Han Tsao, New Taipei City (TW)

(72) Inventors: Hsin-Ying Wu, Yilan County (TW); Cheng-Han Tsao, New Taipei City (TW)

(73) Assignee: AU OPTRONICS CORPORATION, Hsinchu (TW)

(21) Appl. No.: 13/568,131

(22) Filed: Aug. 7, 2012

(30) Foreign Application Priority Data
Mar. 23, 2012 (TW) 101110224

(51) Int. Cl. G02B 27/22

(52) U.S. Cl. 359/462

(57) ABSTRACT

An auto-stereoscopic display apparatus includes a display panel and a lens film. The display panel includes sub-pixel structures along an X-direction and a Y-direction to form a pixel array. A horizontal width of each sub-pixel structure is L1. The lens film is located at one side of the display panel. The lens film includes cylindrical lenses. An included angle is between an extension direction of the cylindrical lenses and the Y-direction. A width of each cylindrical lens in the X-direction is L2, and L2/L1=4.61±0.05. When the number of pixels per inch (PPI) is more than 110, the range of included angle between the extension direction of the cylindrical lenses and the Y-direction is from 16 degrees to 18 degrees. When PPI is less than 110, the range of included angle between the extension direction of the cylindrical lenses and the Y-direction is from 8 degrees to 11 degrees.

### CROSS-REFERENCE TO RELATED APPLICATION

This application claims the priority benefit of Taiwan application serial no. 101110224, filed on Mar. 23, 2012. The entirety of the above-mentioned patent application is hereby incorporated by reference herein and made a part of this specification.

### BACKGROUND OF THE INVENTION

1. Field of the Invention

The invention relates to a display apparatus, and more particularly, to an auto-stereoscopic display apparatus.

2. Description of Related Art

At present, three-dimensional (3D) display technologies can be roughly categorized into auto-stereoscopic technologies that allow a viewer to directly watch images with naked eyes and stereoscopic technologies that require the viewer to wear specially-designed glasses. According to the operational principle of an auto-stereoscopic display apparatus, a fixed barrier is utilized to control images received by left and right eyes of the viewer. On account of visual characteristics of human eyes, when images with the same content but different parallax are respectively captured by the viewer's left and right eyes, the images that seem to be superposed may be perceived as a 3D image. Besides, according to the operational principle of a stereoscopic display apparatus, the display apparatus displays left-eye and right-eye frames that can be respectively sent to the left and right eyes of the viewer who wears glasses, so as to generate a 3D image.

In general, cylindrical lenses are required to be configured on the display panel of the auto-stereoscopic display apparatus, such that the right-eye and left-eye images displayed on the display panel can be respectively sent to the right and left eyes of the viewer. Besides, the cylindrical lenses and the sub-pixel structures are often arranged in parallel. Human eyes may observe dark bands (i.e., Moiré-like patterns, MLP) when the cylindrical lenses focusing on the black matrix between the sub-pixel structures. The MLP significantly deteriorates the display quality of the auto-stereoscopic display apparatus; therefore, how to remove the undesired MLP is one of the issues to be resolved by researchers in this field.

### SUMMARY OF THE INVENTION

The invention is directed to an auto-stereoscopic display apparatus that can effectively reduce MLP and improve display quality.

In an embodiment of the invention, an auto-stereoscopic display apparatus that includes a display panel and a lens film is provided. The display panel includes a plurality of sub-pixel structures. The sub-pixel structures are arranged along an X-direction and a Y-direction to form a pixel array. A horizontal width of each of the sub-pixel structures is L1. The lens film is located at one side of the display panel. Besides, the lens film includes a plurality of cylindrical lenses. An included angle is between an extension direction of the cylindrical lenses and the Y-direction. A width of each cylindrical lens in the X-direction is L2, and L2/L1=4.61±0.05. When the number of pixels per inch (PPI) is more than 110, the included angle between the extension direction of the cylindrical lenses and the Y-direction ranges from about 16 degrees to about 18 degrees. When PPI is less than 110, the included angle between the extension direction of the cylindrical lenses and the Y-direction ranges from about 8 degrees to about 11 degrees.

Based on the above, in the auto-stereoscopic display apparatus described in the embodiments of the invention, the cylindrical lenses are tilted with respect to the sub-pixel structures, so as to lessen the density of dark zones and reduce the possibility of MLP. In addition, through adjusting the ratio of horizontal width of the cylindrical lenses to horizontal width of the sub-pixel structures and modifying the angle at which the cylindrical lenses and the sub-pixel structures are arranged, the auto-stereoscopic display apparatus can have the favorable display quality.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic exploded view illustrating an auto-stereoscopic display apparatus according to an embodiment of the invention.

FIG. 2 is a schematic view illustrating the sub-pixel structure depicted in FIG. 1.

FIG. 3 is a schematic top view illustrating the auto-stereoscopic display apparatus depicted in FIG. 1.

FIG. 4 is a schematic top view illustrating two sub-pixel structure of an auto-stereoscopic display apparatus according to an embodiment of the invention.

FIG. 5 is a schematic top view illustrating a relationship between aperture ratios and locations of the auto-stereoscopic display apparatuses described in the example and the reference example.

### DESCRIPTION OF EMBODIMENTS

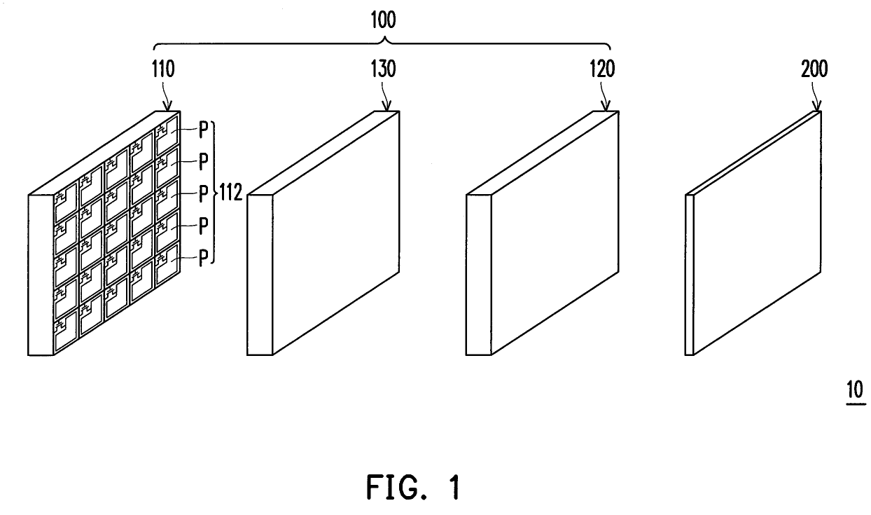

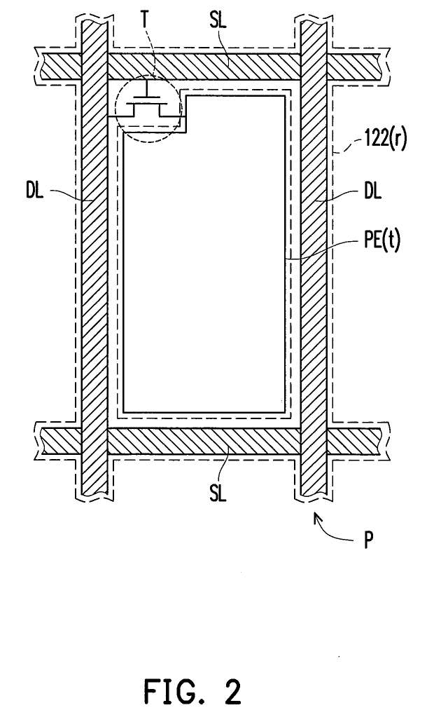

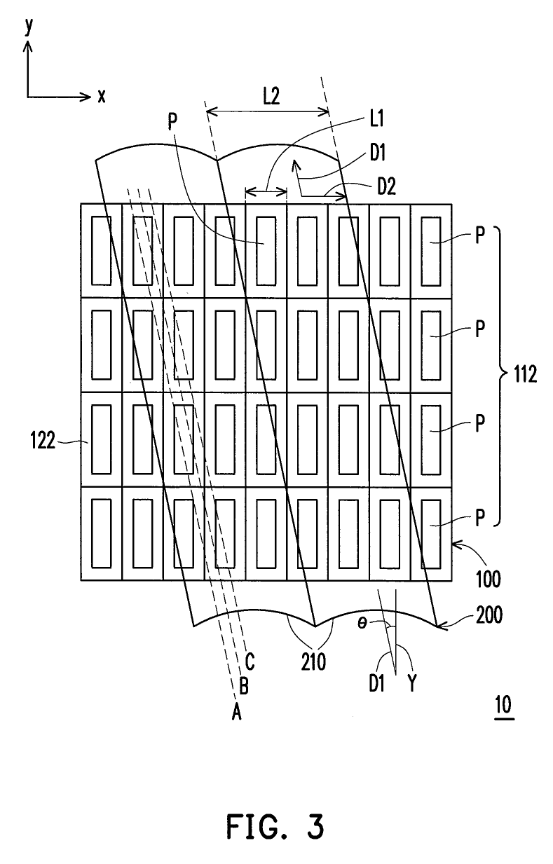

FIG. 1 is a schematic exploded view illustrating an auto-stereoscopic display apparatus according to an embodiment of the invention. FIG. 2 is a schematic view illustrating the sub-pixel structure depicted in FIG. 1. FIG. 3 is a schematic top view illustrating the auto-stereoscopic display apparatus depicted in FIG. 1. Note that one sub-pixel structure P is shown in FIG. 2 for illustrative purposes.

With reference to FIG. 1 and FIG. 2, the auto-stereoscopic display apparatus described in this embodiment includes a display panel 100 and a lens film 200. The lens film 200 is located at one side of the display panel 100. The display panel 100 includes a first substrate 110, a second substrate 120, and a display medium 130. The second substrate 120 is disposed opposite to the first substrate 110. The display medium 130 is located between the first substrate 110 and the second substrate 120. Besides, the display medium 130 is a liquid crystal layer, for instance.

The first substrate 110 is, for instance, an active device array substrate and includes a plurality of sub-pixel structures P. The sub-pixel structures P are arranged along an X-direction and a Y-direction to form a pixel array 112. In general, each of the sub-pixel structures P includes an active device T, a scan line SL, a data line DL, and a pixel electrode PE. The active device T is electrically connected to the scan line SL and the data line DL. The active device T may be a bottom-gate thin film transistor (TFT) or a top-gate TFT, and the active device T includes a gate, a channel, a source, and a drain. The active device T is electrically connected to the scan line SL and the data line DL. The pixel electrode PE is electrically connected to the drain of the active device T. Similar to where the scan line SL and the data line DL are located, where the active device T is located is often a non-transparent region.

The scan line SL and the data line DL are often made of a metallic material. However, the invention is not limited thereto. According to other embodiments, the scan line SL and the data line DL may also be made of any other conductive material. For instance, the conductive material may include an alloy, a metal nitride material, a metal oxide material, a metal oxynitride material, or a layer in which the metal material and another conductive material are stacked. As stated above, the scan line SL and the data line DL are often made of the non-transparent material, and therefore where the scan line SL and the data line DL are located is a non-transparent region.

The sub-pixel electrode PE is made of indium tin oxide (ITO), indium zinc oxide (IZO), or any other proper transparent conductive materials, for instance. Hence, where the sub-pixel electrode PE is located may be a transparent region.

The second substrate 120 is, for instance, a color filter substrate, a substrate having an opposite electrode thereon, or a blank substrate. In most cases, the color filter substrate includes a common electrode layer (not shown), color filter patterns (not shown), and a light-shielding pattern layer 122. The common electrode layer (not shown) is, for instance, made of ITO, IZO, or any other appropriate transparent conductive material. The color filter patterns (not shown) are, for instance, red filter patterns, green filter patterns, blue filter patterns, or other appropriate filter patterns. The light-shielding pattern layer 122 may be disposed corresponding to the non-transparent region in the sub-pixel structure P. Namely, the light-shielding pattern layer 122 may be disposed corresponding to the scan line SL, the data line DL, the active device T, and any other light-shielding region in the sub-pixel structure P, so as to form a non-transparent region r. On the contrary, a transparent region t is formed at a location where the light-shielding pattern layer 122 is not disposed. According to the present embodiment, the second substrate 120 is the color filter substrate, for instance, which should not be construed as a limitation to the invention. In other words, if the second substrate 120 has the opposite electrode thereon, or the second substrate 120 is a blank substrate, the color filter patterns (not shown) and the light-shielding pattern layer 122 may be disposed on the first substrate 110 to form the non-transparent region r and the transparent region t.

According to the present embodiment, the lens film 200 is located at one side of the display panel 100, and the side of the display panel 100 is relatively close to a user. With reference to FIG. 3, the lens film 200 includes a plurality of cylindrical lenses 210. The cylindrical lenses 210 can transform the display image into a right-eye display light beam and a left-eye display light beam, such that the right-eye and left-eye images displayed on the display panel can be respectively sent to the right and left eyes of the user.

In order to elaborate the arrangement of the sub-pixel structures P and the lens film 200 in the present embodiment, only the sub-pixel structures P, the light-shielding pattern layer 122, and the lens film 200 are shown, and the other components are omitted in FIG. 3. Moreover, two cylindrical lenses 210 are depicted in FIG. 3, while the number of the cylindrical lenses 210 in the lens film 200 is not limited in the invention.

According to the present embodiment, a horizontal width of each of the sub-pixel structures P is L1. To be specific, the horizontal width refers to the width of the sub-pixel structure P in the X-direction.

In the present embodiment, an included angle θ is between an extension direction D1 of the cylindrical lenses 210 and the Y-direction. Particularly, the extension direction D1 of the cylindrical lenses 210 is not parallel to the arrangement of the sub-pixel structures P along the Y-direction. In the present embodiment, a width of each cylindrical lens 210 in the X-direction is L2, and the width L2 may also refer to the horizontal vector of the width of the cylindrical lens 210.

As described above, the ratio (L2/L1) of the width L2 of each cylindrical lens 210 in the X-direction to the horizontal width L1 of each sub-pixel structure P is 4.61±0.05, for instance. Specifically, the ratio (L2/L1) of the width L2 of each cylindrical lens 210 in the X-direction to the horizontal width L1 of each sub-pixel structure P represents the number of the sub-pixel structures P corresponding to each cylindrical lens 210. That is, each cylindrical lens 210 may correspond to plural sub-pixel structures P. According to the present embodiment, if L2/L1=4.61±0.05, for instance, the MLP may be lessened. In a preferred embodiment of the invention, if L2/L1=4.61±0.02, for instance, the MLP may be lessened to a better extent.

In the present embodiment, when the number of pixels per inch (PPI) is more than 110, the included angle θ between the extension direction of the cylindrical lenses 210 and the Y-direction ranges from about 16 degrees to about 18 degrees. When PPI is less than 110, the included angle θ between the extension direction of the cylindrical lenses 210 and the Y-direction ranges from about 8 degrees to about 11 degrees. When the resolution is relatively high, the tilting included angle between the cylindrical lenses 210 and the sub-pixel structures P is relatively large. When the resolution is relatively low, the tilting included angle between the cylindrical lenses 210 and the sub-pixel structures P is relatively small. By adjusting the tilting included angle, the auto-stereoscopic display apparatus 10 can lessen the MLP, such that the auto-stereoscopic display apparatus 10 can have favorable display quality.

In addition to the adjustment of the tilting included angle between the cylindrical lenses 210 and the sub-pixel structures P, the light-shielding pattern layer 122 in the display panel 100 can also be adjusted. In the present embodiment, the light-shielding pattern layer 122 is disposed corresponding to the sub-pixel structures P. The light-shielding pattern layer 122 is a black matrix, for instance. From a user's direction of sight, the light-shielding pattern layer 122 is located between each of the sub-pixel structures P, such that each sub-pixel structure P may have a transparent region t and a non-transparent region r. The adjustment of the light-shielding pattern layer 122 corresponding to the sub-pixel structures P is elaborated hereinafter.

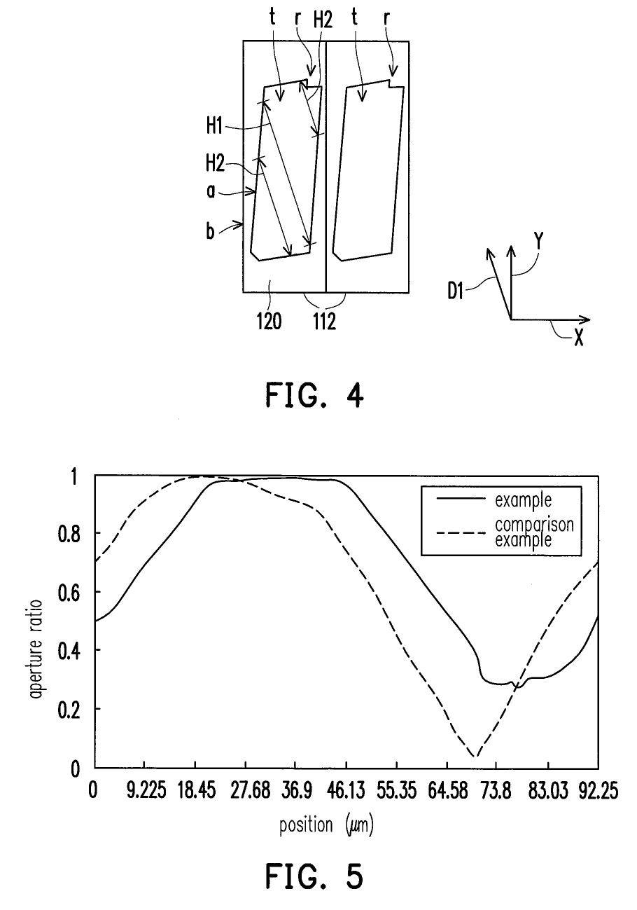

FIG. 4 is a schematic top view illustrating two sub-pixel structures of an auto-stereoscopic display apparatus according to an embodiment of the invention. With reference to FIG. 4, in the present embodiment, the light-shielding pattern layer 122 is disposed corresponding to the sub-pixel structures P, such that each sub-pixel structure P has the transparent region t and the non-transparent region r. According to the present embodiment, a long-side edge a of the transparent region t in each of the sub-pixel structures P is not parallel to a long-side edge b of the non-transparent region r. The non-parallel configuration of the long-side edges of the transparent region t and the non-transparent region r may further rectify the possible uneven brightness issue of the auto-stereoscopic display apparatus 10.

In light of the foregoing, along the extension direction D1 of the cylindrical lenses, each of the sub-pixel structures P has a transparent length H2 in the transparent region t, and the transparent lengths H2 at different horizontal positions are different. Here, the maximum transparent length is H1. When PPI is more than 110, H2/H1=0.7±0.3, for instance. However, the invention is not limited thereto, and according to a preferred embodiment, when PPI is more than 110, H2/H1=0.8±0.2, for instance. By contrast, when PPI is less than 110, H2/H1=0.65±0.35, for instance. By adjusting the maximum transparent length H1 and the transparent lengths H2 of the sub-pixel structures P, the dark zones are less likely to be generated in the auto-stereoscopic display apparatus 10, such that the auto-stereoscopic display apparatus 10 can have favorable display quality.

The following example is provided to explain the effect achieved by the non-parallel configuration of the long-side edge of the transparent region t and the long-side edge b of the non-transparent region r in each sub-pixel structure P.

### EXAMPLE

The auto-stereoscopic display apparatus described in the example includes the sub-pixel structure shown in FIG. 4 and cylindrical lenses that are arranged in a tilt manner, and the long-side edge of the transparent region is not parallel to the long-side edge of the non-transparent region. The auto-stereoscopic display apparatus described in the example and the auto-stereoscopic display apparatus described in a reference example are similar, while the difference lies in that the long-side edge of the transparent region in the sub-pixel structure is parallel to the long-side edge of the non-transparent region according to the reference example.

FIG. 5 is a schematic top view illustrating a relationship between aperture ratios and locations of the auto-stereoscopic display apparatuses described in the example and the reference example. A method of measuring the aperture ratio is described herein with reference to FIG. 3. The location is defined from the sectional line A to the sectional line C along the X-direction through the sectional line B, so as to complete the measurement of the aperture ratio of the auto-stereoscopic display apparatus. Here, the aperture ratio is normalized, and the resultant relationship between the aperture ratios and the locations of the auto-stereoscopic display apparatuses is shown in FIG. 5.

With reference to FIG. 5, the aperture ratio of the auto-stereoscopic display apparatus is relatively low when the measurement position ranges from 64.58 μm to 73.8 μm according to the reference example, while the aperture ratio of the auto-stereoscopic display apparatus in the example is relatively average. Accordingly, it can be learned from FIG. 5 that the auto-stereoscopic display apparatus in the example may have even brightness. Besides, owing to the non-parallel configuration of the long-side edges of the transparent region and the non-transparent region in each sub-pixel structure, the MLP effect may be further alleviated.

To sum up, in the auto-stereoscopic display apparatus described in the embodiments of the invention, the cylindrical lenses are tilted with respect to the sub-pixel structures. In addition, through adjusting the ratio of horizontal width of the cylindrical lenses to horizontal width of the sub-pixel structures and modifying the angle at which the cylindrical lenses and the sub-pixel structures are arranged, the dark zones can be reduced, and thereby the auto-stereoscopic display apparatus can have the favorable display quality. Moreover, through the non-parallel configuration of the long-side edges of the transparent region and the non-transparent region in each sub-pixel structure and the adjustment of the ratio of the diagonal length of the sub-pixel structure to the diagonal length in the transparent region, the issue of the uneven image brightness can be resolved to a better extent, and the MLP effect may be alleviated. As such, the display quality of the auto-stereoscopic display apparatus can be further improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An auto-stereoscopic display apparatus comprising:
a display panel comprising a plurality of sub-pixel structures arranged along an X-direction and a Y-direction to form a pixel array, wherein a horizontal width of each of the sub-pixel structures is L1; and
a lens film located at a side of the display panel, the lens film comprising a plurality of cylindrical lenses, wherein each of the cylindrical lenses in the X-direction has a width L2, an included angle is between an extension direction of the cylindrical lenses and the Y-direction,
L2/L1=4.61±0.05,
when the number of pixels per inch is more than 110, the included angle between the extension direction of the cylindrical lenses and the Y-direction ranges from about 16 degrees to about 18 degrees, and
when the number of pixels per inch is less than 110, the included angle between the extension direction of the cylindrical lenses and the Y-direction ranges from about 8 degrees to about 11 degrees.

2. The auto-stereoscopic display apparatus as recited in claim 1, wherein L2/L1=4.63±0.02.

3. The auto-stereoscopic display apparatus as recited in claim 1, wherein the display panel further includes a light-shielding pattern layer disposed corresponding to the sub-pixel structures, such that each of the sub-pixels structures has one transparent region and one non-transparent region, each of the sub-pixel structures has a transparent length H2 in the transparent region, and a maximum transparent length is H1.

4. The auto-stereoscopic display apparatus as recited in claim 3, wherein H2/H1=0.7±0.3 when the number of pixels per inch is more than 110.

5. The auto-stereoscopic display apparatus as recited in claim 4, wherein H2/H1=0.8±0.2.

6. The auto-stereoscopic display apparatus as recited in claim 3, wherein H2/H1=0.65±0.35 when the number of pixels per inch is less than 110.

7. The display apparatus as recited in claim 3, wherein a long-side edge of the transparent region in each of the pixel structures is not parallel to a long-side edge of the non-transparent region.

8. The auto-stereoscopic display apparatus as recited in claim 1, wherein each of the cylindrical lenses is disposed corresponding to several sub-pixel structures of the pixel structures.
